(19) United States
(12) Patent Application Publication
(10) Pub. No.: US 2023/0004877 A1
(43) Pub. Date: Jan. 5, 2023

(54) METHOD AND APPARATUS FOR PROVIDING COUNSELING SERVICE

(71) Applicant: KAKAO CORP., Jeju-si (KR)

(72) Inventors: Ho Jun LEE, Seongnam-si (KR); Jung Han CHOI, Seongnam-si (KR); Bo Mi HONG, Seongnam-si (KR); June Kwon MOON, Seongnam-si (KR)

(21) Appl. No.: 17/853,937

(22) Filed: Jun. 30, 2022

(30) Foreign Application Priority Data
Jun. 30, 2021 (KR) 10-2021-0085958

(51) Int. Cl. G06Q 10/02; H04L 51/04; G06Q 50/10

(52) U.S. Cl. CPC G06Q 10/02; H04L 51/04; G06Q 50/10

(57) ABSTRACT

Provided are a method and apparatus for providing a counseling service. A method of operating a counseling center server interworking with an instant messaging service includes receiving a message of a first user regarding a counseling request through a chat room of a channel of a second user registered in the service, creating a first counseling ticket of the channel, acquiring the number of counseling tickets in a waiting state allocated to each of accounts of a plurality of counselors linked to the channel, allocating the first counseling ticket to an account of a first counselor among the accounts of the counselors, and updating a state of the first counseling ticket to the waiting state.

### CROSS-REFERENCE TO RELATED APPLICATION

This application claims the benefit of Korean Patent Application No. 10-2021-0085958 filed on Jun. 30, 2021, in the Korean Intellectual Property Office, the entire disclosure of which is incorporated herein by reference for all purposes.

### BACKGROUND

### 1. Field of the Invention

One or more example embodiments relate to a method and apparatus for providing a counseling service.

### 2. Description of the Related Art

Recently, with development of mobile smart devices, the use of online platform services for interaction with other users through networks is increasing. Typical examples of the online platform services for interaction with other users include a social networking service (SNS), which is an online platform that creates and strengthens social relationships through communication, information sharing, and social network expansion among users, and an instant messaging service (IMS), which is an online platform for real-time content communication among two or more users. As the interaction among users through such mobile devices increases, the online platform service supports not only a chat service for daily conversation with other users, but also a function of providing various services based on communication among a plurality of users.

Contact center as a service (CCaaS) is a cloud-based service-type contact center solution may be a service that provides an online counseling platform with various counseling functions including a chat interface and a chatbot. There is a need for development of CCaaS technology for companies to efficiently conduct and manage counseling by applying smart technology while consumers may request non-face-to-face counseling using mobile devices in an easy and quick way.

### SUMMARY

According to an aspect, there is provided a method of operating a counseling center server interworking with an instant messaging service, including receiving a message of a first user regarding a counseling request through a chat room of a channel of a second user registered in the service, creating a first counseling ticket of the channel corresponding to the chat room based on the received message, acquiring the number of counseling tickets in a waiting state allocated to each of accounts of a plurality of counselors linked to the channel based on a database in which information on a counseling ticket of the channel is stored, allocating the first counseling ticket to an account of a first counselor among the accounts of the counselors based on the number of the counseling tickets in the waiting state acquired to correspond to each of the accounts of the counselors, and updating a state of the first counseling ticket to the waiting state based on the allocation of the first counseling ticket.

The allocating of the first counseling ticket may include comparing the number of the counseling tickets in the waiting state acquired to correspond to each of the accounts of the counselors with a predetermined first threshold value, and allocating the first counseling ticket to the account of the first counselor when the number of counseling tickets in the waiting state allocated to the account of the first counselor is less than the first threshold value, based on a result of the comparison.

The allocating of the first counseling ticket may include allocating the first counseling ticket to the account of the first counselor having the smallest number of allocated counseling tickets in the waiting state among the accounts of the counselors.

The allocating of the first counseling ticket may include receiving an allocation request for the first counseling ticket from a terminal of the first counselor, comparing the number of the counseling tickets in the waiting state allocated to the account of the first counselor with a first predetermined threshold value, and allocating the first counseling ticket to the account of the first counselor based on a result of the comparison.

The updating of the state of the first counseling ticket to the waiting state may include providing the chat room through a chat interface for counseling provided to a terminal of the first counselor.

The updating of the state of the first counseling ticket to the waiting state may further include updating the state of the first counseling ticket to a progress state in response to a connection request with the first counseling ticket received from the first counselor through the chat interface.

The updating of the state of the first counseling ticket to the progress state may include acquiring the number of counseling tickets in the progress state allocated to the account of the first counselor in response to the connection request with the first counseling ticket, maintaining the state of the first counseling ticket when the acquired number of the counseling tickets in the progress state exceeds a predetermined second threshold value, and updating the state of the first counseling ticket to the progress state when the acquired number of the counseling tickets in the progress state does not exceed the second threshold value.

The connection request with the first counseling ticket may include at least one of a request for access to the chat room corresponding to the first counseling ticket, and a request for transmission of a message through the chat room corresponding to the first counseling ticket.

The chat interface may include a list of chat rooms corresponding to the counseling tickets in the waiting state allocated to the account of the first counselor, and a list of chat rooms corresponding to progressing counseling tickets allocated to the account of the first counselor.

The updating of the state of the first counseling ticket to the waiting state may further include monitoring a state change condition of the first counseling ticket updated to the waiting state, and updating the state of the counseling ticket to a progress state, a pending state, or an end state based on a result of the monitoring.

The database may be configured to store, to correspond to the channel, at least one of information on the account of the counselor allocated with the counseling ticket, information on the state of the counseling ticket, and information on a chat log corresponding to the counseling ticket.

According to another aspect, there is provided a method of operating a counseling center server interworking with an instant messaging service, including receiving a message of a first user regarding a counseling request through a chat room of a channel of a second user registered in the service, creating a first counseling ticket of the channel corresponding to the chat room based on the received message, determining a category of the first counseling ticket based on the received message, allocating the first counseling ticket to an account of a first counselor corresponding to the determined category among accounts of a plurality of counselors linked to the channel, and updating a state of the first counseling ticket to a waiting state based on the allocation of the first counseling ticket.

The allocating of the first counseling ticket may include selecting accounts of second counselors corresponding to the determined category among the accounts of the counselors, acquiring the number of counseling tickets in the waiting state allocated to each of the accounts of the second counselors based on a database in which information on a counseling ticket corresponding to counseling requested for the channel is stored, and allocating the first counseling ticket to the account of the first counselor among the accounts of the second counselors based on the number of the counseling tickets in the waiting state acquired to correspond to each of the accounts of the second counselors.

According to another aspect, there is provided a method of operating a terminal of a first counselor using a counseling service interworking with a counseling center server, including receiving counseling tickets allocated to an account of a first counselor and states of the allocated counseling tickets from the counseling center server, displaying a chat interface for counseling including a list of chat rooms corresponding to the allocated counseling tickets, receiving an input for requesting a connection to a first counseling ticket among the allocated counseling tickets from the first counselor, receiving the state of the first counseling ticket whose update is determined based on the number of counseling tickets in a progress state among the allocated counseling tickets from the server, and controlling the chat interface based on the received state of the first counseling ticket.

The list of chat rooms may include at least one list distinguished by the states of the counseling tickets.

The controlling of the chat interface may include displaying a chat room corresponding to the first counseling ticket in a first list corresponding to the progress state when the state of the first counseling ticket is updated to the progress state, and displaying the chat room corresponding to the first counseling ticket in a second list corresponding to a waiting state when the state of the first counseling ticket is maintained in the waiting state.

The displaying of the chat interface for counseling may further include receiving a list of unallocated counseling tickets from the server, receiving an input for requesting allocation of a second counseling ticket among the unallocated counseling tickets from the first counselor, receiving, from the server, the state of the second counseling ticket whose update is determined based on the number of counseling tickets in a waiting state among the allocated counseling tickets, and displaying a chat room corresponding to the second counseling ticket on the chat interface based on the received state of the second counseling ticket.

According to another aspect, there is provided a counseling center server interworking with an instant messaging service including at least one processor configured to receive a message of a first user regarding a counseling request through a chat room of a channel of a second user registered in the service, create a first counseling ticket of the channel corresponding to the chat room based on the received message, acquire the number of counseling tickets in a waiting state allocated to each of accounts of a plurality of counselors linked to the channel based on a database in which information on a counseling ticket of the channel is stored, allocate the first counseling ticket to an account of a first counselor among the accounts of the counselors based on the number of the counseling tickets in the waiting state acquired to correspond to each of the accounts of the counselors, and update a state of the first counseling ticket to the waiting state based on the allocation of the first counseling ticket.

According to another aspect, there is provided a counseling center server interworking with an instant messaging service including at least one processor configured to receive a message of a first user regarding a counseling request through a chat room of a channel of a second user registered in the service, create a first counseling ticket of the channel corresponding to the chat room based on the received message, determine a category of the first counseling ticket based on the received message, allocate the first counseling ticket to an account of a first counselor corresponding to the determined category among accounts of a plurality of counselors linked to the channel, and update a state of the first counseling ticket to a waiting state based on the allocation of the first counseling ticket.

According to another aspect, there is provided a terminal of a first counselor using a counseling service interworking with a counseling center server including at least one processor configured to receive counseling tickets allocated to a logged-in account and states of the allocated counseling tickets from the counseling center server, display a chat interface for counseling including a list of chat rooms corresponding to the allocated counseling tickets, receive an input for requesting a connection to a first counseling ticket among the allocated counseling tickets, receive the state of the first counseling ticket whose update is determined based on the number of counseling tickets in a progress state among the allocated counseling tickets from the server, and control the chat interface based on the received state of the first counseling ticket.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an operation flowchart of a method of operating a counseling center server interworking with an instant messaging service according to an example embodiment;

FIGS. 2A and 2B are diagrams illustrating an example embodiment of requesting counseling through a channel of a second user;

FIGS. 3A and 3B are diagrams illustrating examples of a chat interface provided by a server according to an example embodiment;

FIG. 4 is a diagram illustrating an example of information on a counseling ticket stored in a database to correspond to a channel of a second user;

FIG. 5 is an operation flowchart illustrating a method of operating a counseling center server interworking with an instant messaging service according to an example embodiment;

FIG. 6 is a diagram illustrating a category of counseling according to an example embodiment;

FIG. 7 is an operation flowchart illustrating a method of operating a terminal of a first counselor using a counseling service interworking with an instant messaging service according to an example embodiment;

FIG. 8 is a diagram illustrating an example of an interface provided to a terminal of a first counselor linked to a channel of a second user;

FIGS. 9A to 9C are diagrams illustrating a list of chat rooms included in an interface provided to a terminal of a first counselor according to an example embodiment;

FIGS. 10A and 10B are diagrams illustrating an example embodiment in which a counselor requests allocation of a counseling ticket through an interface provided to a terminal according to an example embodiment;

FIG. 11 is a diagram illustrating an example embodiment of displaying a message regarding a state change of a counseling ticket allocated to a counselor; and

FIG. 12 is an exemplary diagram illustrating a configuration of a counseling system according to an example embodiment.

### DETAILED DESCRIPTION

Although terms such as first or second may be used to describe various components, these terms should be interpreted only for the purpose of distinguishing one component from another. For example, a first component may be termed a second component, and similarly, a second component may also be termed a first component.

When a component is referred to as being “connected to” another component, it may be directly connected or coupled to the other component, but it should be understood that another component may exist therebetween.

The singular expression includes the plural expression unless the context clearly dictates otherwise. In the specification, terms such as “comprise” or “have” are intended to designate that the described feature, number, step, operation, component, part, or combination thereof exists, and it should be understood that the possibility of presence or addition of one or more other features or numbers, steps, operations, components, parts or combinations thereof is not excluded in advance.

Hereinafter, example embodiments will be described in detail with reference to the accompanying drawings. In describing with reference to the accompanying drawings, the same components are assigned with the same reference numerals regardless of the numerals on the drawings, and overlapping descriptions thereof will be omitted.

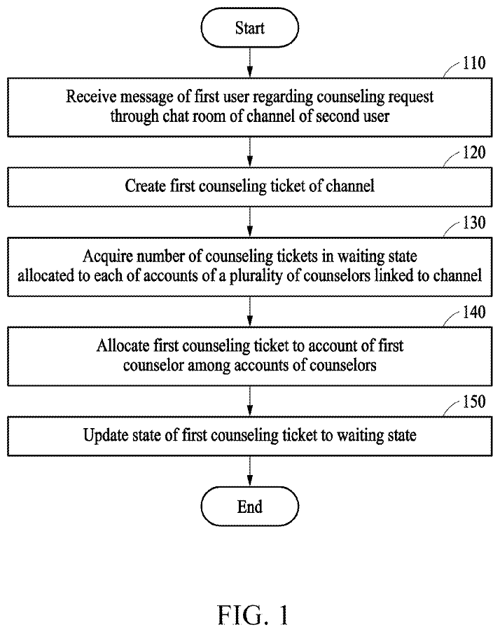

FIG. 1 is an operation flowchart illustrating a method of operating a counseling center server interworking with an instant messaging service according to an example embodiment.

Referring to FIG. 1, the method of operating a counseling center server interworking with an instant messaging service according to an example embodiment includes receiving a message of a first user regarding a counseling request through a chat room of a channel of a second user (110), creating a first counseling ticket of the channel (120), acquiring the number of counseling tickets in a waiting state allocated to each of accounts of a plurality of counselors linked to the channel (130), allocating the first counseling ticket to an account of a first counselor among the accounts of the counselors (140), and updating a state of the first counseling ticket to the waiting state (150).

The counseling center server according to an example embodiment may correspond to a server that provides a counseling service by interworking with an instant messaging service. The counseling service is a counseling service that uses an instant messenger connected to an instant messaging server for providing an instant messaging service as a counseling medium, and a user may use the counseling service through a registered account or by subscribing to the instant messaging service. The counseling center server and the instant messaging server may be included in a counseling system for providing the counseling service, and a detailed configuration of the counseling system will be described in detail with reference to FIG. 14 below.

The instant messaging server according to an example embodiment may provide various types of accounts, such as a personal account, a corporate account, or a service account, to use the instant messaging service. The personal account may be an account for a general user, the corporate account may be an account for a specific company, and the service account may be an account for a specific service. The corporate account or the service account may be referred to as a channel.

The counseling service according to an example embodiment may be provided in the form of the counseling through a channel registered in the instant messaging service. Counseling through the channel may refer to the counseling conducted in a chatting manner between the channel and another account that requests the counseling on the channel. For example, the counseling service may be provided in a chatting manner using an instant messenger between a personal account (an individual account) of the first user corresponding to a general user and the channel of the second user corresponding to a specific company or a specific service provider. Hereinafter, the counseling center server may be briefly referred to as a server.

Operation 110 according to an example embodiment may include receiving the message of the first user regarding the counseling request through the chat room of the channel of the second user registered in the instant messaging service. The first user may correspond to a user who has a personal account, a corporate account, or a service account registered in the instant messaging service, and the second user may correspond to a user who has a corporate account or a service account registered in the instant messaging service.

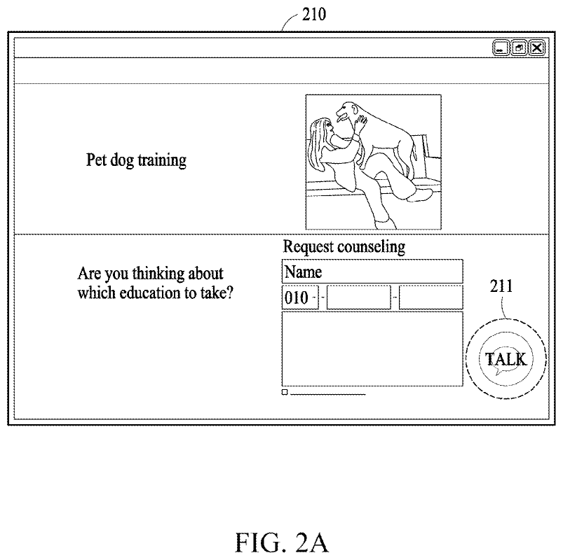

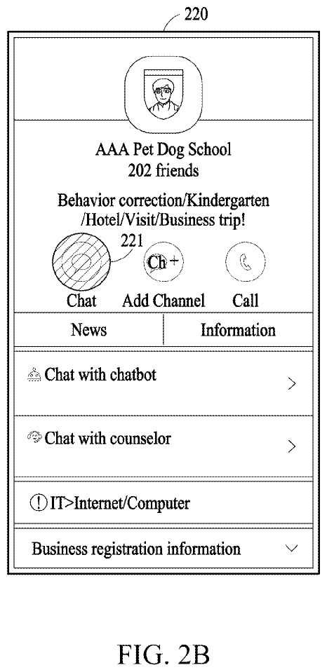

According to an example embodiment, the first user may request the instant messaging server for the counseling through the channel of the second user using a terminal. As an example, the terminal or the first user may be input with a command from the first user for requesting the counseling from a website or application linked to the channel of the second user and transmit a signal for requesting the instant messaging server for the counseling through the channel of the second user. For example, referring to FIG. 2A, the terminal of the first user responses to an input of the first user who selects (e.g., clicks) a button 211 for requesting the counseling on a website 210 linked to the channel of the second user to transmit a signal requesting the counseling through the channel of the second user to the instant messaging server. As another example, the terminal of the first user may request the counseling on the channel of the second user through an interface related to the channel of the second user provided in the instant messenger. For example, referring to FIG. 2B, the terminal of the first user responses to an input of the first user who selects (e.g., clicks) a button 221 for requesting the counseling on an interface 220 related to the channel of the second user provided in the instant messenger to transmit a signal for requesting the counseling through the channel of the second user to the instant messaging server. In this case, the counseling request for the channel of the second user may be transmitted to the counseling center server through the instant messaging server.

The instant messaging server according to an example embodiment may create the chat room for the channel of the second user that the account of the first user participates in response to the input of the first user requesting the counseling on the channel of the second user. The chat room may correspond to a virtual chat space in which at least one account or channel participates. The chat room of the channel may correspond to a chat room in which the channel or an account linked to the channel participates. The chat room of the channel may be provided in a different type from the general chat room, and a corporate message including notification information or promotional information related to the company or the service may be transmitted through the chat room. In other words, the instant messaging server may create a chat room in which the first user's account and the second user's channel participate in response to the input of the first user requesting the counseling on the channel of the second user.

According to an example embodiment, the chat room of the channel may include a chat room for counseling. The chat room for counseling is a chat space for conducting the counseling between a counselor linked to the channel and a user who requested the counseling. The chat room for counseling may be connected to a counselor linked to the channel or to a chat bot linked to the channel.

The instant messaging server may provide a chat interface for counseling corresponding to the chat room for counseling to the terminal of the first user. The chat interface for counseling may correspond to a user interface for transmitting and receiving chat messages for counseling and displaying the transmitted and received messages.

According to an example embodiment, when the terminal of the first user who requested the counseling through the channel of the second user is not logged in to the instant messaging service, the instant messaging server may request the terminal of the first user to log in for the instant messaging service. For example, the instant messaging server may call an instant messenger application installed in the terminal of the first user and provide an interface for logging in to an account registered in the instant messaging service. The instant messaging server may provide a chat interface for counseling corresponding to the channel of the second user to the terminal of the first user logged in to the instant messaging service with the account of the first user. Hereinafter, description will be followed by assuming that the terminal of the first user is logged in with the account of the first user registered in the instant messaging service.

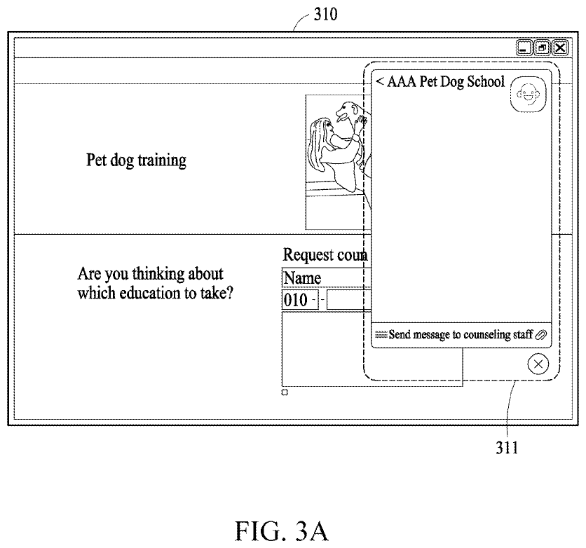

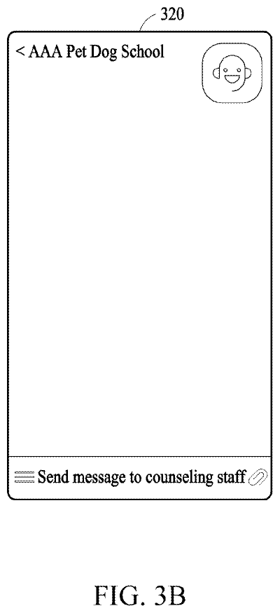

For example, when an input of the first user requesting the counseling is received from the website, the instant messaging server may provide a chat interface in the form of web chatting through the website. For example, referring to FIG. 3A, the instant messaging server responses to a counseling request through a website 310 to provide a chat interface 311 for counseling corresponding to the second channel in the form of web chatting through the website 310. Also, it is possible to provide a chat interface through an instant messenger application by calling the instant messenger application installed in the terminal of the first user. For example, referring to FIG. 3B, the instant messaging server responds to a counseling request through a website or a counseling request through a channel interface of the second user provided in the instant messenger so as to call the instant messenger application installed in the terminal of the first user and provide a chat interface 320 through the called instant messenger application.

According to an example embodiment, the terminal of the first user logged in with the account of the first user may send a message of the first user regarding the counseling request to the chat room of the channel of the second user in which the account of the first user participates through the chat interface. The message transmitted to the chat room may be transmitted to the instant messaging server, and the instant messaging server may deliver the same to the counseling center server. In other words, operation 110 according to an example embodiment may include receiving the message of the first user from the instant messaging server.

According to an example embodiment, operations of creating the chat room described above, requesting login, and providing the chat interface described above as being performed in the instant messaging server may be performed in the counseling center server. In this case, operation 110 according to an example embodiment may include receiving, by the counseling center server, the message of the first user directly from the terminal logged in with the account of the first user.

According to an example embodiment, the channel of the second user may be linked to the account of at least one counselor. The account of the counselor may correspond to an account registered in the instant messaging service or the counseling center server. The account of the counselor linked to the channel of the second user may conduct the counseling by transmitting and receiving a message to and from the account of the first user who requested the counseling for the channel through the chat room of the channel. The account of the counselor linked to the channel of the second user may correspond to an account to which access to the chat room of the channel is granted. The right to access the chat room of the channel may correspond to the right to transmit a message through the chat room of the channel using the channel and receive the message transmitted through the chat room of the channel. For example, a message transmitted through the chat room of the channel by an account of a counselor linked to the channel of the second user may be displayed as a message transmitted by the channel. In other words, the message transmitted through the chat room of the channel by the account of the counselor linked to the channel of the second user may be displayed as a message transmitted from the channel of the second user, not by the account of the counselor.

According to an example embodiment, the right to access the chat room of the channel for the account of the counselor linked to the channel of the second user may be limited to a part of the chat room of the channel. As will be described in detail below, the account of the first counselor may have a right to access some of chat rooms of the second user's channel, and the account of the second counselor may have a right to access some other chat rooms of the second user's channel. When the account of the first counselor linked to the channel of the second user is not granted access to a first chat room of the channel, the account of the first counselor may not be allowed to transmit a message through the first chat room using the channel. On the other hand, reading the messages transmitted and received through the chat room of the channel may be allowed even to the account of the counselor who does not have access to the chat room.

Operation 120 according to an example embodiment may correspond to creating a first counseling ticket of the channel corresponding to the chat room based on the message input received in operation 110. For example, the message received from the first user may be input through the chat interface for counseling provided in the terminal of the first user as described above, and may be received by the counseling center server through the instant messaging server.

According to an example embodiment, a counseling ticket is a unit of counseling objectified in the server, and the counseling ticket may correspond to a session for the counseling between a specific user account and a specific channel. The counseling ticket may be created to correspond to the chat room of the channel, and the counseling between the user account and the channel through the chat room of the channel may be objectified as a counseling ticket to be stored in a server or a database accessible from the server. For example, the counseling ticket may include a chat log transmitted and received between a specific user account and a specific channel through the corresponding chat room.

The first counseling ticket according to an example embodiment may be created when there is a message input of the account of the first user through the chat room of the channel of the second user created in response to the counseling request input from the first user. In other words, the first counseling ticket may be created as the first user who requested the counseling inputs a chat message in the chat room of the channel of the second user through the chat interface for counseling. Hereinafter, ‘chat interface for counseling’ may be briefly referred to as ‘chat interface’ or ‘interface’.

As described above, a plurality of chat rooms for the channel may be created, and as a chat message is input to the plurality of chat rooms, a plurality of counseling tickets corresponding to each chat room may be created. According to an example embodiment, one or more counseling tickets may be created through the same chat room. For example, a first chat room of the channel including the account of the first user is created first, a counseling ticket may be created by a chat message first input through the first chat room, and after the counseling ticket ends, another counseling ticket may be created by an input of a chat message through the chat room.

According to an example embodiment, the counseling ticket may correspond to any one of a plurality of states corresponding to the progress of the counseling. The state of the counseling ticket may be updated upon the occurrence of an event related to the counseling ticket that occurs in the course of the counseling. As an example, the counseling ticket may be changed from a first state to a second state as a first event related to the counseling ticket occurs, and may be changed from the second state to a third state as a second event related to the counseling ticket occurs.

According to an example embodiment, the state of the counseling ticket may include the waiting state and a progress state. The waiting state may correspond to a state that is changed as an allocation event related to a counseling ticket occurs, and the progress state may correspond to a state that is changed as a counseling connection event related to a counseling ticket occurs. An allocation event related to a counseling ticket may occur when the counseling ticket is allocated to an account of a specific counselor. The counseling connection event related to the counseling ticket may occur when the account of the counselor allocated with the counseling ticket accesses the chat room corresponding to the counseling ticket or transmits a message through the chat room corresponding to the counseling ticket.

According to an example embodiment, the state of the counseling ticket may include an unallocated state as a default state. The default state is an initial state of a counseling ticket that is set as an event for creating a counseling ticket occurs, and may correspond to a state before an event that changes the state of the counseling ticket occurs. The counseling ticket in the unallocated state may be changed to the waiting state as an allocation event occurs.

According to an example embodiment, the state of the counseling ticket may further include an end state and/or a pending state. The state and state change of the counseling ticket will be described in detail below.

Operation 130 according to an example embodiment may include acquiring the number of counseling tickets in the waiting state allocated to each of the accounts of a plurality of counselors linked to the channel based on a database in which information on counseling tickets of the channel is stored.

The database in which the information on the counseling ticket of the channel is stored according to an example embodiment is a storage space for storing the counseling ticket(s) previously created to correspond to the channel, and may be implemented in a memory within a server or a storage device accessible from a server.

According to an example embodiment, the database may be configured to store information on the counseling ticket to correspond to each channel. For example, the information on the counseling ticket may include information on an account of a counselor to which the counseling ticket is allocated, information on the state of the counseling ticket, and/or information on a chat log corresponding to the counseling ticket. In other words, the database may store, to correspond to the channel, at least one of the information on the account of the counselor to which the counseling ticket is allocated, information on the state of the counseling ticket, and the information on the chat log corresponding to the counseling ticket.

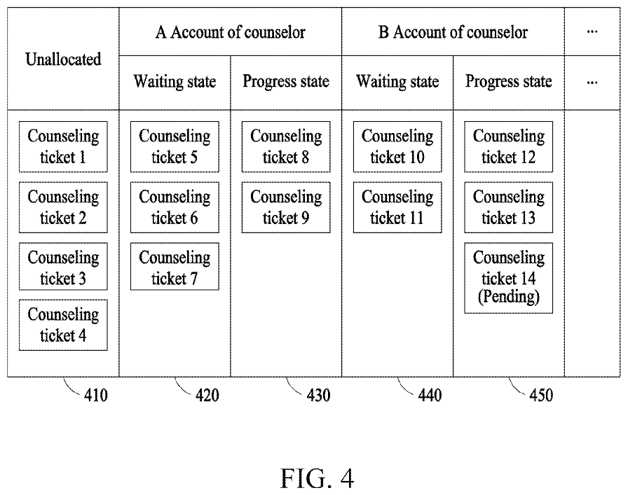

As an example, FIG. 4 is a diagram illustrating an example of information on a counseling ticket stored in a database to correspond to the channel of the second user. Referring to FIG. 4, the database stores lists 420, 430, 440, and 450 for each state of counseling tickets allocated to the account of each counselor linked to a channel and a list of counseling tickets 410 unallocated to the accounts of the counselors so as to store information on the account of the counselor to which the counseling ticket is allocated. ‘Counseling ticket 1’ to ‘counseling ticket 14’ shown in FIG. 4 visually show instances of counseling tickets created to correspond to channels, and data corresponding to each counseling ticket such as identification information and chat logs corresponding to the counseling ticket may be actually stored in the database. Although not shown in FIG. 4, the database according to an example embodiment may further include information on the counseling ticket such as identification information on the counseling ticket, information on duration of the counseling ticket, and information on the history of state change of the counseling ticket.

The server according to an example embodiment may access the database to acquire the number of counseling tickets in the waiting state allocated to each of the accounts of a plurality of counselors linked to the channel. For example, referring to FIG. 4, the server may acquire the number of counseling tickets in the waiting state allocated to the account of each counselor, based on lists 420 and 440 of the counseling tickets in the waiting state allocated to the account of each counselor. According to the example shown in FIG. 4, the acquired number of counseling tickets in the waiting state allocated to the account of counselor A may be three, and the acquired number of counseling tickets in the waiting state allocated to the account of counselor B may be two.

Referring back to FIG. 1, operation 140 according to an example embodiment may include allocating a first counseling ticket to the account of the first counselor among accounts of counselors based on the acquired number of counseling tickets in the waiting state corresponding to each account of counselors. Allocating of the first counseling ticket to the account of the first counselor may mean granting access to the chat room corresponding to the first counseling ticket to the account of the first counselor. The chat room corresponding to the first counseling ticket may indicate the chat room in which the message of the first user is received in operation 110. As described above, the account of the first counselor who is granted access to the chat room corresponding to the first counseling ticket may transmit a message through the chat room using the channel of the second user, and receive the message transmitted through the chat room. In other words, the account of the first counselor who is granted access to the chat room corresponding to the first counseling ticket uses the channel of the second user to transmit and receive messages to and from the account of the first user through the chat room so that counseling may be conducted.

According to an example embodiment, operation 140 of allocating the first counseling ticket may include allocating the first counseling ticket to an account of the first counselor having the smallest number of allocated counseling tickets in the waiting state among the accounts of counselors. For example, as shown in FIG. 4, when counseling tickets are allocated to the account of the counselor A and that of counselor B, the first counseling ticket may be allocated to the account of the counselor B with the smallest number of counseling tickets in the waiting state.

According to an example embodiment, when there is a plurality of accounts of counselors with the smallest number of allocated counseling tickets in the waiting state, the first counseling ticket may be allocated to any one account of a counselor based on a predetermined criterion among the plurality of accounts of counselors. The predetermined criterion may include, for example, a criterion set to be randomly determined via a method such as random number extraction, a criterion set to be determined in an ascending order of identification information regarding the account of the counselor, and/or a criterion set to be allocated to the account of the counselor with the smallest number of counseling tickets in the progress state.

According to an example embodiment, operation 140 of allocating the first counseling ticket may include comparing the number of counseling tickets in the waiting state acquired to correspond to each of the accounts of counselors with a predetermined first threshold value, and allocating the first counseling ticket to the account of the first counselor whose number of allocated counseling tickets in the waiting state is less than the first threshold value, based on the comparison result. The first threshold value may be a predetermined value corresponding to the channel. For example, the first threshold value may be set as a default value or may be set as a value determined by the second user.

For example, as shown in FIG. 4, when counseling tickets are allocated to the account of counselor A and the account of counselor B while the first threshold value is set to 3, the first counseling ticket may be allocated to the account of the counselor B whose number of counseling tickets in the waiting state is less than 3.

According to an example embodiment, when there is a plurality of accounts of a counselor whose number of allocated counseling tickets in the waiting state is less than the first threshold value, the first counseling ticket may be allocated to any one of counselor's accounts according to a predetermined criterion among the plurality of counselor's accounts. The predetermined criterion may include, for example, a criterion set to be randomly determined via a method such as random number extraction, a criterion set to be determined in ascending order of identification information regarding an account of a counselor, and/or a criterion set to be allocated to an account of a counselor with the smallest number of counseling tickets in the waiting state.

For example, as shown in FIG. 4, when the counseling ticket is allocated to the account of the counselor A and the account of the counselor B while the first threshold value is set to 4, the first counseling ticket may be allocated to any one of counselor's account according to the predetermined criterion since the number of counseling tickets in the waiting state allocated to both the account of the counselor A and the account of the counselor B is less than four. For example, according to the criterion set to be randomly determined by random number extraction, when a number of 0.5 or less is derived by random number extraction of 0 or more and 1 or less, allocation is conducted to the account of the counselor A, and when a number exceeds 0.5, allocation is conducted to the account of the counselor B. As another example, according to the criterion set to be determined in an ascending order of the identification information regarding the account of the counselor, the account of the counselor to be allocated may be determined by the alphabetical order of the identification information. As another example, according to the criterion set to be allocated to the account of the counselor with the smallest number of counseling tickets in the waiting state, allocation may be conducted to the account of the counselor B having the smaller number of counseling tickets in the waiting state.

According to an example embodiment, operation 140 of allocating the first counseling ticket may include receiving an allocation request for the first counseling ticket from the terminal of the first counselor, comparing the number of the counseling ticket in the waiting state allocated to the account of the first counselor with a first predetermined threshold value, and allocating the first counseling ticket to the account of the first counselor based on the comparison result.

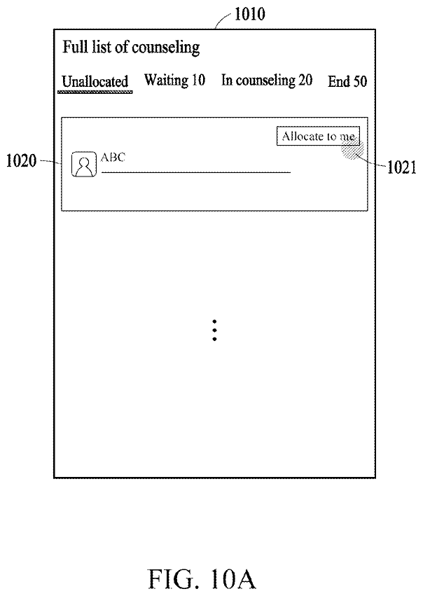

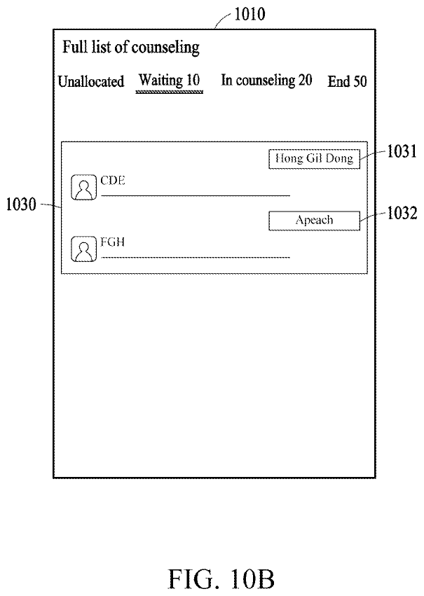

According to an example embodiment, the counselor linked to a specific channel may request the server for allocation of a counseling ticket in the unallocated state through an interface provided from the server to the terminal of the counselor. An example embodiment that a counselor requests allocation of a counseling ticket through the interface provided to the terminal will be described in detail with reference to FIG. 10 below.

According to an example embodiment, when the allocation of the first counseling tickets in the unallocated state is requested from the terminal of the first counselor, the server may determine the allocation by comparing the number of the counseling tickets in the waiting state allocated to the first counselor's account and a predetermined first threshold value. As an example, the server may allocate the first counseling ticket to the account of the first counselor when the number of counseling tickets in the waiting state allocated to the account of the first counselor is less than the predetermined first threshold value. In other cases, allocation may not be conducted.

According to an example embodiment, the counseling ticket created in the server may be allocated to any one of accounts of a plurality of counselors linked to the channel of the second user based on a category into which the corresponding counseling ticket is classified. A method of allocating a counseling ticket based on the category of the counseling ticket will be described in detail below.

Operation 150 according to an example embodiment may include updating the state of the first counseling ticket to the waiting state based on the allocation of the first counseling ticket.

According to an example embodiment, operation 150 of updating of the state of the first counseling ticket to the waiting state may further include providing the chat room corresponding to the first counseling ticket through a chat interface for counseling provided to the terminal of the first counselor.

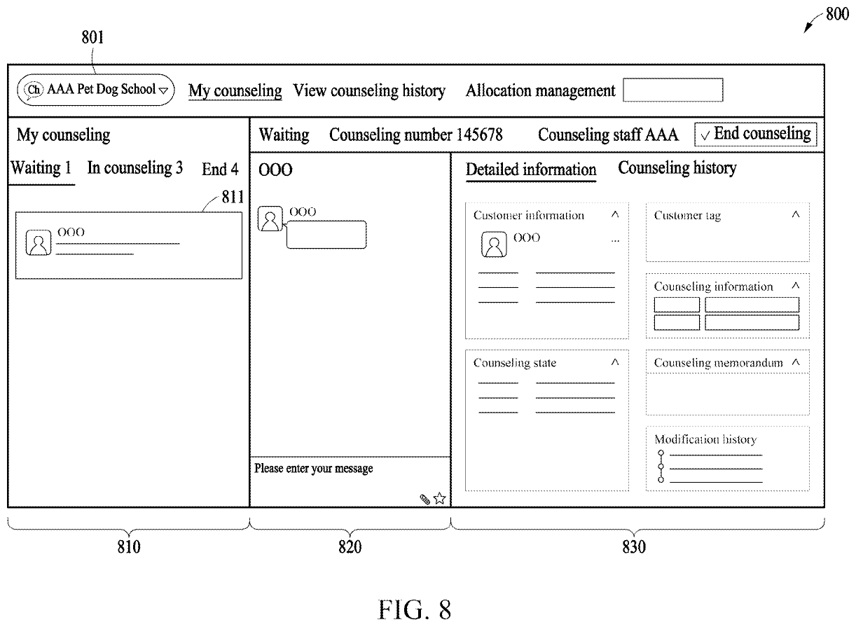

The interface provided to the terminal of the first counselor according to an example embodiment may include a list of chat rooms corresponding to the counseling ticket in the waiting state allocated to the account of the first counselor and a list of the chat rooms corresponding to progressing counseling tickets allocated to the account of the first counselor. When the first counseling ticket is allocated to the account of the first counselor, the chat room corresponding to the first counseling ticket may be added to the list of chat rooms corresponding to the counseling tickets in the waiting state included in the interface. The first counselor may access the chat room through the interface and also access the chat room to transmit/receive chat messages for counseling with the account of a user participating in the chat room. A specific example of the interface provided to the terminal of the first counselor according to an example embodiment will be described in detail with reference to FIGS. 8 to 10 below.

Operation 150 according to an example embodiment may further include monitoring a state change condition of a first counseling ticket updated to the waiting state, and updating the state of the counseling ticket to the progress state, the pending state, or the end state based on the monitoring result. The first counseling ticket may be updated from the waiting state to another state as the state change condition is satisfied. The state change condition may be satisfied when an event related to a predetermined counseling ticket occurs. The monitoring of a state change condition of a first counseling ticket in a server may include detecting occurrence of an event related to a first counseling ticket.

For example, operation 150 of updating of the state of a first counseling ticket to the waiting state may further include updating the state of the first counseling ticket to the progress state, in response to a connection request with the first counseling ticket received from the first counselor through the chat interface provided to the terminal of the first counselor. The state change condition for changing the state of the first counseling ticket from the waiting state to the progress state may be satisfied by the occurrence of an event in which a connection request with the first counseling ticket of the first counselor is received.

According to an example embodiment, the connection request with the first counseling ticket may include at least one of a request for access to the chat room corresponding to the first counseling ticket and a request for transmission of a message through the chat room corresponding to the first counseling ticket. In other words, when the first counselor requests access to the chat room corresponding to the first counseling ticket through the chat interface provided to the terminal, the server may recognize that there is a connection request with the first counseling ticket. Alternatively, when the first counselor accesses the chat room corresponding to the first counseling ticket through the chat interface provided in the terminal and requests transmission of a message through the chat room, the server may recognize that there is a connection request with the first counseling ticket.

According to an example embodiment, the state change condition may further include a condition regarding the number of counseling tickets. In other words, the state change condition may be satisfied when an event related to a predetermined counseling ticket occurs and the condition regarding the number of counseling tickets is satisfied. In this case, the monitoring of the state change condition of the first counseling ticket in the server may include detecting the occurrence of an event related to the first counseling ticket and determining whether the condition regarding the number of counseling tickets is satisfied

For example, the state change condition for updating the state of the counseling ticket to the progress state may further include a condition regarding the number of counseling tickets allocated to the account of the counselor, in addition to the occurrence of an event that a connection request with the counseling ticket is received from the counselor. In other words, when the connection request with the first counseling ticket is received from the terminal of the first counselor, the server compares the number of counseling tickets in the progress state allocated to the account of the first counselor with a second threshold value so as to decide whether to update the counseling ticket. More specifically, the updating of the state of the first counseling ticket to the progress state may include acquiring the number of counseling tickets in the progress state allocated to the account of the first counselor in response to a connection request with the first counseling ticket, maintaining the state of the first counseling ticket when the number of acquired counseling tickets in the progress state exceeds the second predetermined threshold value, and updating the state of the first counseling ticket to the progress state when the number of the acquired counseling tickets in the progress state does not exceed the second threshold value. The second threshold value may be a predetermined value corresponding to the channel, and may be set as, for example, a default value or as a value determined by the second user.

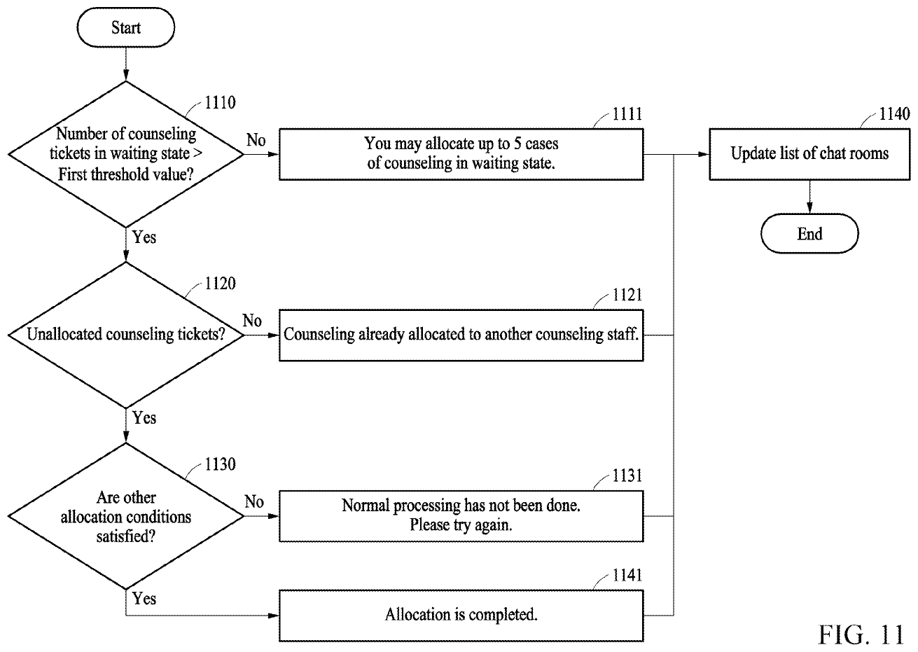

For example, as shown in FIG. 4, when counseling tickets are allocated to the account of the counselor A and the account of counselor B, the second threshold value is set to 3. When a connection request with ‘counseling ticket 5’ is received from the terminal of the counselor A, the state of ‘counseling ticket 5’ may be updated to the progress state since the number of counseling tickets in the progress state allocated to the account of counselor A is less than 3. On the other hand, when a connection request with ‘counseling ticket 10’ is received from the terminal of counselor B, the state of ‘counseling ticket 10’ may not be updated to the progress state since the number of counseling tickets in the progress state allocated to the account of the counselor B corresponds to 3 or more. As will be described in detail below, ‘counseling ticket 14’ corresponding to the pending state may be included in a list of counseling tickets in the progress state. In other words, when counting the number of counseling tickets in the progress state, the counseling tickets in the pending state may be counted as counseling tickets in the progress state. When the state of the counseling ticket requested to be connected is not changed due to non-compliance with the condition regarding the number of counseling tickets, the server may notify the counselor who has requested the connection that the connection with the counseling ticket failed or the state of the counseling ticket has not been changed through the interface. An example embodiment for notifying the counselor that the state has not been changed through the interface in the server will be described in detail with reference to FIG. 11 below.

According to an example embodiment, the state of the counseling ticket may further include the end state. A state change condition for the state of the first counseling ticket to be changed to the end state may be satisfied by occurrence of an end event. In other words, the end state may correspond to a state that is changed by the occurrence of the end event of the counseling ticket. Counseling tickets in the unallocated state, waiting state, or progress state may be changed to the end state as the end event occurs. For example, the counseling ticket in the unallocated state, waiting state, or progress state may be updated to the end state by the occurrence of the end event, such as cases that a command is received from a user and/or a counselor requesting the end of the counseling and/or there is no response from a user for a certain period of time.

According to an example embodiment, the state of the counseling ticket may further include the pending state. A state change condition for changing the state of the first counseling ticket to the pending state may be satisfied by the occurrence of a pending event. In other words, the pending state may correspond to a state that is changed as the pending event occurs in the progress state of the counseling ticket. A counseling ticket in the progress state may be changed to the pending state as the pending event occurs. For example, the counseling ticket in the progress state may be updated to the pending state by the occurrence of the pending event, such as a case when a command for requesting pending of the counseling is received from a counselor.

The pending state according to an example embodiment may be recognized as a detailed state of the progress state. For example, when counting the number of counseling tickets in the server, the counseling ticket in the pending state may be treated as a counseling ticket in the progress state. As another example, the chat room corresponding to the counseling ticket in the pending state may be displayed in the list of chat rooms corresponding to the counseling ticket in the progress state. Meanwhile, unlike a counseling ticket in a general progress state, the state of the counseling ticket in the pending state may not be changed to the end state even though the end event related to the counseling ticket occurs.

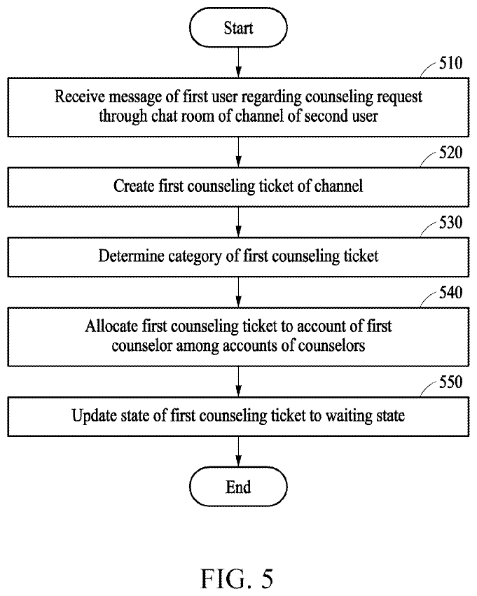

FIG. 5 is an operation flowchart of a method of operating a counseling center server interworking with an instant messaging service according to an example embodiment.

Referring to FIG. 5, the method of operating the counseling center server interworking with the instant messaging service according to an example embodiment may include receiving a message of a first user regarding a counseling request through a chat room of a channel of a second user (510), creating a first counseling ticket of the channel (520), determining a category of the first counseling ticket (530), allocating the first counseling ticket to an account of a first counselor among accounts of counselors (540), and updating the state of the first counseling ticket to the waiting state (550).

Operations 510 and 520 according to an example embodiment may correspond to operations 110 and 120 in FIG. 1 described above, respectively.

Operation 530 according to an example embodiment may include determining the category of the first counseling ticket based on at least one of a counseling request input and a message input received from the first user. The first user may input a category of counseling when a counseling request is input and/or when a message for counseling is input through the chat room created upon the counseling request. For example, by selecting any one of a plurality of options regarding the category of counseling provided through an interface provided to the terminal of the first user when inputting the message, the input the category of counseling may be conducted.

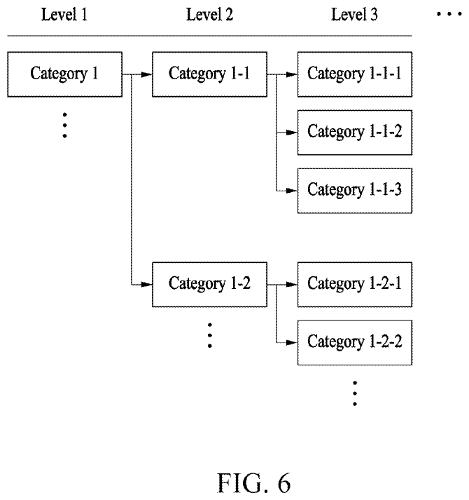

The category of counseling according to an example embodiment may include a plurality of values corresponding to a plurality of levels. For example, referring to FIG. 6, the category of counseling may include categories in levels 1 to 3, and ‘category 1’ in level 1 may be subdivided two ‘categories 1-1’ or ‘categories 1-2’ in levels 2 which are subcategories thereof. Each of the categories in level 2 may be subdivided into a category in level 3 which is a subcategory thereof, respectively. For example, when the channel of the second user is a channel related to banking services and the first user requests counseling for a loan through the channel of the second user, ‘category 1’ may correspond to ‘loan’ and a category in level 2, which is a subcategory of ‘category 1’ may correspond to ‘credit loan’, ‘mortgage loan’, and the like.

According to an example embodiment, the instant messaging server may provide an interface of a chat window for inputting a category of counseling to the terminal of the first user accessing the chat room of the channel. For example, the instant messaging server may provide the interface of the chat window capable of transmitting an input for selecting any one of the category options corresponding to level 1 to the terminal of the first user accessing the chat room. The first user may transmit a message input for selecting a category corresponding to level 1 to the server through the interface provided to the terminal. When the first user selects ‘category 1’ as a category corresponding to level 1 by input of a message, an input window for selecting any one of ‘category 1-1’ and ‘category 1-2’ corresponding to level 2, which is a subcategory of ‘category 1’ may be provided to the terminal of the first user through the interface. An interfacing object that the first user may sequentially select categories for each level may be provided through the interface, and the first user may sequentially input categories of counseling through the interface. After receiving the input of categories of counseling for all levels, an input window for inputting a message for counseling may be provided through the interface.

Operation 540 according to an example embodiment may include allocating the first counseling ticket to the account of the first counselor corresponding to the category determined in operation 530 among the accounts of the plurality of counselors linked to the channel of the second user. Each of the accounts of the plurality of counselors linked to the channel of the second user may be assigned to be in charge of a specific category of counseling. A counseling ticket corresponding to the category determined in operation 530 may be allocated to an account of a counselor assigned to the category. For example, when the category determined in operation 530 corresponds to the first category, the counseling ticket may be assigned to any one of accounts of the counselor assigned to be in charge of the first category.

According to an example embodiment, operation 540 of allocating the first counseling ticket may include allocating the first counseling ticket to the account of the first counselor based on the category of the first counseling ticket and the number of counseling tickets in the waiting state allocated to each of the accounts of counselors. For example, when there is a plurality of counselor accounts corresponding to the category of the first counseling ticket, an account of the first counselor to be allocated with the first counseling ticket may be determined in consideration of the number of counseling tickets in the waiting state allocated to the accounts of the counselors corresponding to the category of the first counseling ticket. More specifically, operation 540 of allocating the first counseling ticket may include selecting accounts of second counselors corresponding to the determined category among the accounts of the counselors, acquiring the number of counseling tickets in the waiting state allocated to each of the accounts of the second counselors based on the database storing information on a counseling ticket corresponding to the counseling requested for the channel, and allocating the first counseling ticket to the account of the first counselor among the accounts of the second counselors based on the number of counseling tickets in the waiting state acquired to correspond to each of the accounts of the second counselors. For example, as described above with respect to operation 140 in FIG. 1, the first counseling ticket may be allocated to the account of the first counselor with the smallest number of allocated counseling tickets in the waiting state among the accounts of the second counselors, or may be allocated to the account of the first counselor whose number of allocated counseling tickets in the waiting state is less than the first threshold value among accounts of the second counselors. Alternatively, when there is a plurality of counselor accounts whose number of allocated counseling tickets in the waiting state is less than the first threshold value among the accounts of the second counselor, the first counseling ticket may be allocated to an account of any one counselor according to the above-described predetermined criteria.

Operation 550 according to an example embodiment may correspond to operation 150 in FIG. 1. In other words, as described above with reference to FIG. 1, the server may monitor the state change condition to update the counseling ticket of the first counseling ticket.

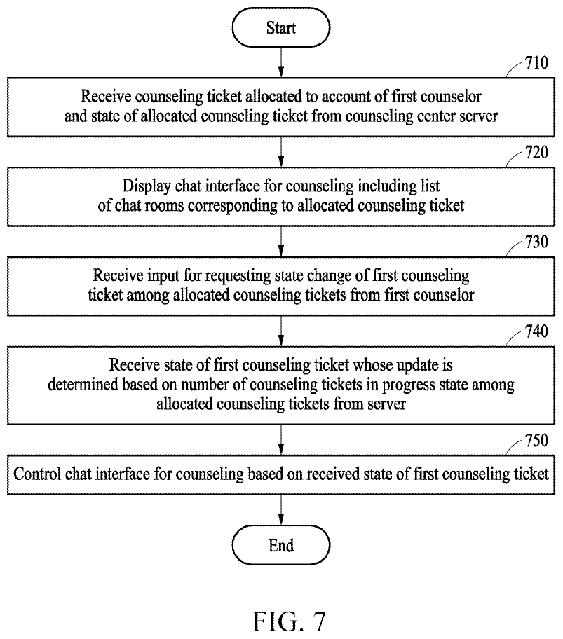

FIG. 7 shows an operation flowchart of a method of operating a terminal of a first counselor using a counseling service interworking with a counseling center server according to an example embodiment.

Referring to FIG. 7, the method of operating the terminal of the first counselor using the counseling service interworking with the counseling center server according to an example embodiment may include receiving a counseling ticket allocated to an account of a first counselor and the state of the allocated counseling ticket from the counseling center server (710), displaying a chat interface for counseling including a list of chat rooms corresponding to the allocated counseling ticket (720), receiving an input for requesting a state change of a first counseling ticket among allocated counseling tickets from the first counselor (730), receiving the state of the first counseling ticket whose update is determined based on the number of counseling tickets in the progress state among the allocated counseling tickets from the server (740), and controlling the chat interface for counseling based on the received state of the first counseling ticket (750). The terminal of the first counselor is a terminal logged in with the account of a counselor linked to a specific channel which may correspond to the channel of the second user described above, and the account of the counselor may correspond to the instant messaging service provided by the server and/or the account registered in the counseling center server.

Operation 710 according to an example embodiment may include receiving the counseling ticket allocated to the account of the first counselor and the state of the allocated counseling ticket from the server based on the database storing information on the counseling ticket to correspond to the channel described above in FIG. 1.

Operation 720 according to an example embodiment, the chat interface for counseling is an interface provided from the server to the terminal of the first counselor and may include a list of at least one chat room distinguished by the state of the counseling ticket. For example, FIG. 8 illustrates an example of an interface provided to the terminal of the first counselor linked to the channel 801 of the second user. Referring to FIG. 8, the interface 800 provided to the terminal of the first counselor may include a chat room list 810 corresponding to the counseling ticket allocated to the account of the first counselor. The chat room list 810 may include a plurality of lists distinguished by the state of the counseling ticket corresponding to the chat room.

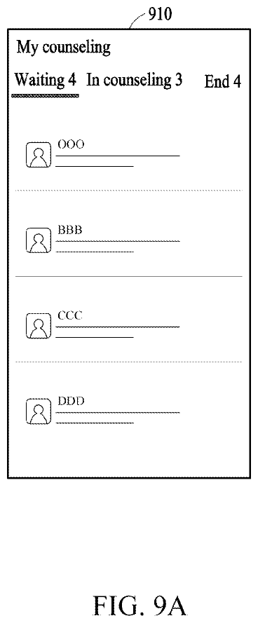

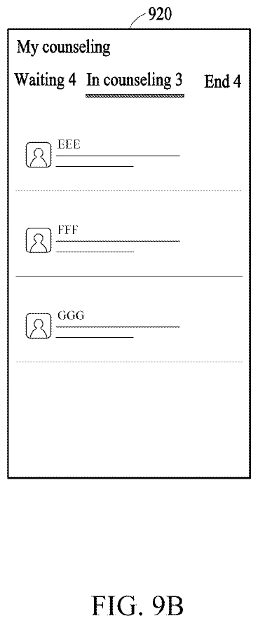

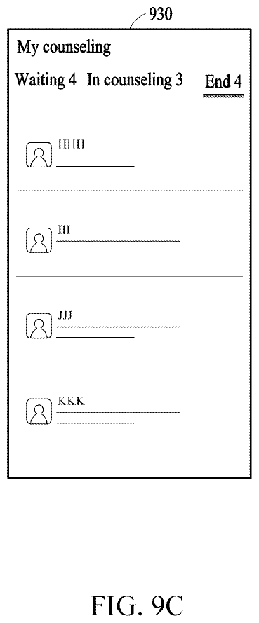

More specifically, referring to FIGS. 9A to 9C, the interface provided to the terminal of the first counselor may include a chat room list 910 corresponding to a counseling ticket in the waiting state, a chat room list 920 corresponding to a counseling ticket in the progress state, and a chat room list 930 counseling to the counseling ticket in the end state.

Referring back to FIG. 8, the first counselor may request access to the chat room from the server by clicking an interfacing object 811 related to the chat room displayed in the chat room list. For example, when the first counselor requests access to the chat room in the server by clicking on the interfacing object 811 for the chat room, the server responds to the access request and provide the chat window 820 corresponding to the chat room on the terminal of the first counselor. The first counselor may request the server to transmit the message to the account of the first user participating in the chat room by inputting the message into the chat window 820. The first counselor may conduct the counseling with the user by transmitting and receiving a message to and from the account of the user participating in the chat room through the chat window 820.

According to an example embodiment, the chat interface 800 may further include a window 830 for providing information on the counseling ticket in addition to the chat room list 810 and the chat window 820. The information on the counseling ticket may include, for example, information on the user who requested the counseling, information on the state of the counseling ticket, and information on the duration of the counseling corresponding to the counseling ticket.

According to an example embodiment, operation 730 may include receiving a connection request with the first counseling ticket input from the first counselor through an interface provided to the terminal of the first counselor. As described above, the first counselor may transmit a connection request with the first counseling ticket to the server by requesting access to the chat room corresponding to the first counseling ticket. Alternatively, the first counselor may transmit the connection request with the first counseling ticket to the server by accessing the chat room corresponding to the first counseling ticket to request for the message transmission.

Operation 740 according to an example embodiment may include receiving the state of the first counseling ticket determined to update to the progress state or maintain in the waiting state based on the number of counseling tickets in the progress state allocated to the account of the first counselor from the server. As described above, when a connection request with the first counseling ticket is received from the first counselor, the server may update the state of the first counseling ticket to the progress state based on whether the number of counseling tickets in the progress state allocated to the account of the first counselor exceeds the second threshold value.

According to an example embodiment, operation 750 of controlling the chat interface for counseling may include displaying the chat room corresponding to the first counseling ticket to a first list corresponding to the progress state when the state of the first counseling ticket is updated to the progress state, and displaying the chat room corresponding to the first counseling ticket on a second list corresponding to the waiting state when the state of the first counseling ticket is maintained in the waiting state. For example, when the state of the counseling ticket corresponding to the chat room included in the second list 910 corresponding to the waiting state shown in FIG. 9A is updated from the waiting state to the progress state, the chat room may be moved to the first list 920 corresponding to the progress state shown in FIG. 9B.

As described above, the first counselor linked to the channel of the second user may request allocation of the counseling ticket from the server through the interface provided to the terminal of the first counselor in the server. Hereinafter, in order to distinguish and specify the counseling ticket with allocation requested by the first counselor from other counseling tickets, the counseling ticket will be referred to as a second counseling ticket. In other words, operation 720 according to an example embodiment may further include receiving a list of unallocated counseling tickets from a server, receiving an input requesting allocation of a second counseling ticket among unallocated counseling tickets from the first counselor, receiving the state of a second counseling ticket whose update is determined based on the number of counseling tickets in the waiting state among allocated counseling tickets from the server, and displaying the chat room corresponding to the second counseling ticket on the chat interface based on the state of the received second counseling ticket.

For example, referring to FIGS. 10A and 10B, the chat interface provided to the terminal of the first counselor may include a chat room list 1010 corresponding to entire counseling tickets created to correspond to the channel of the second user. Referring to FIG. 10A, the chat room list 1010 corresponding to entire counseling tickets may include a chat room list 1020 corresponding to counseling tickets in the unallocated state. For example, the counselor may request allocation of the second counseling ticket in the unallocated state to the server by clicking a button 1021 for requesting allocation corresponding to the second counseling ticket included in the chat interface. When a request for allocation of the second counseling ticket is received from the first counselor, the server may determine whether to allocate the second counseling ticket based on the number of counseling tickets in the waiting state allocated to the account of the first counselor.

Referring to FIG. 10B, the chat room list 1010 corresponding to entire counseling tickets according to an example embodiment may further include a chat room list 1030 corresponding to counseling tickets in the waiting state allocated to the account of any one counselor. The counseling ticket corresponding to the chat room included in the chat room list 1030 may include a chat room corresponding to the counseling ticket allocated to the account of another counselor linked to the channel of the second user as well as the account of the first counselor, and may display information 1031 and 1032 of the allocated account of counselors.

According to an example embodiment, when the state of the counseling ticket allocated to the account of the first counselor is changed, the server may display information on the change in the state of the counseling ticket through the chat interface provided to the terminal of the first counselor. For example, by displaying a message regarding the state change through the chat interface provided in the terminal of the first counselor, information on the state change of the counseling ticket may be notified to the first counselor.

FIG. 11 is a diagram for describing an example embodiment of displaying a message regarding a state change of a counseling ticket allocated to a counselor.

Referring to FIG. 11, when an allocation request for a counseling ticket in the unallocated state is received from the counselor, the server may determine whether the number of counseling tickets in the waiting state allocated to the account of the counselor exceeds a first threshold value (1110). As a result of the determination, when exceeding the first threshold value, a message for notifying the same to the terminal of the counselor may be displayed (1111) without allocating the counseling ticket to the account of the counselor. As a result of the determination, when not exceeding the first threshold value, other state change conditions of the counseling ticket may be sequentially determined. For example, by determining whether the counseling ticket with allocation requested is in the allocated state (1120), determination for the next condition is proceeded if the counseling ticket is in the unallocated state (1130). If the counseling ticket is already allocated to the account of another counselor, instead of allocating the counseling ticket to the account of the counselor, a message for notifying the purport to the terminal of the counselor may be displayed (1121). The order of determination for the condition 1110 and the condition 1120 according to an example embodiment may be changed. Moreover, when there are other allocation conditions, by determining whether other allocation conditions are satisfied (1130), the counseling ticket is finally allocated to the account of the counselor if the allocation condition is satisfied. If the allocation conditions are not satisfied, a message for notifying the same to the terminal of the counselor may be displayed (1131) without allocating the ticket to the account of the counselor.

When the operation of determining whether to allocate the server regarding the allocation request is completed, the chat room list corresponding to the counseling ticket may be updated (1140) by reflecting the allocation. For example, if the counseling ticket in the unallocated state is allocated to the account of the counselor, the state of the counseling ticket may be changed to the waiting state and display the chat room corresponding to the counseling ticket on the chat room list provided to the counselor. When the counseling ticket is allocated to the account of the counselor, a message for notifying the same to the terminal of the counselor may be displayed (1141). If the counseling ticket in the allocated state is not allocated to the account of the counselor, the chat room list may be maintained.

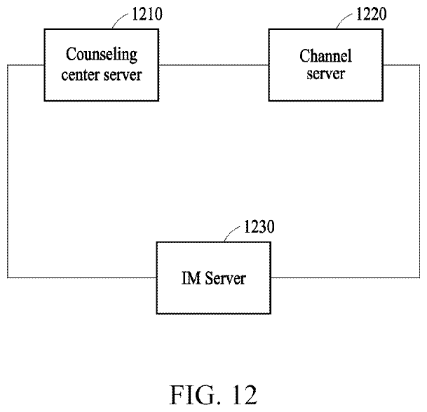

FIG. 12 is an example diagram of a counseling system configuration according to an example embodiment.

Referring to FIG. 12, a counseling system according to an example embodiment may include a counseling center server 1210, a channel server 1220, and an instant messaging server 1230 (hereinafter, IM server).

The counseling system may perform an operation related to a counseling service conducted in a chatting manner between the personal account of the first user corresponding to a general user and the channel of the second user corresponding to a specific company or a specific service provider. The counselor linked to the channel of the second user may communicate with the counseling center server 1210 through a counseling center app installed in the terminal of the counselor or the counseling center web connected from the terminal of the counselor, and may also transmit and receive a message through the chat room by connecting to the chat room of the channel of the second user. The first user may communicate with the IM server 1230 through the instant messaging app installed in the terminal of the first user or the instant messaging web accessed from the terminal, and may also transmit and receive a message through the chat room by connecting to the chat room of the channel of the second user.

According to an example embodiment, the message transmitted from the terminal of the first user through the chat room of the channel may be transmitted to the IM server 1230. The IM server 1230 may transmit the message to the channel server 1220, and the channel server 1220 may transmit the same to the counseling center server 1210.

According to an example embodiment, the counseling center server 1210 receiving the message may create a counseling ticket corresponding to the chat room when no counseling ticket corresponding to the chat room of the channel to which the message is transmitted is created. The counseling center server 1210 may allocate the counseling ticket created to correspond to the chat room of the channel of the second user to the account of the first counselor among the accounts of the counselor linked to the channel of the second user. The counseling center server 1210 may transmit a message received through the chat room corresponding to the second type of counseling ticket to the terminal of the first counselor to which the counseling ticket is allocated.

The terminal of the first counselor according to an example embodiment may request transmission of a message through the chat room corresponding to the allocated counseling ticket to the counseling center server 1210, and the counseling center server 1210 may transmit the message to the terminal of the first user connected to the chat room through the IM server 1230.

According to an example embodiment, the terminal of the first counselor and the counseling center server may correspond to electronic devices including a memory and a processor. The terminal of the first counselor and the counseling center server may communicate through a network.

The terminal of the first counselor according to an example embodiment may be a fixed terminal implemented as a computer device or a mobile terminal. For example, the terminal of the first counselor may include a smart phone, a mobile phone, a computer, a laptop computer, a terminal for digital broadcasting, a personal digital assistant (PDA), a portable multimedia player (PMP), and a tablet PC.

The processor of the terminal of the first counselor according to an example embodiment may perform operations of the terminal of the first counselor using the counseling service interworking with the instant messaging service described above in FIG. 7, and the processor of the counseling center server may perform operations of the counseling center server interworking with the instant messaging service described above in FIG. 1 and/or FIG. 5.

The terminal of the first counselor and the memory of the counseling center server according to an example embodiment is a computer-readable recording medium which may be a volatile memory or a non-volatile memory. The memory of the counseling center server according to an example embodiment may store information related to the provision of the counseling service described above with reference to FIG. 1 and/or FIG. 5, including, for example, a counseling ticket including a chat log related to counseling for each registered channel and a database storing information on a counseling ticket of the channel. The memory of the terminal of the first counselor according to an example embodiment may store information on the counseling service described above with reference to FIG. 7 and include a code for a browser or application installed and driven in the terminal by files provided from the counseling center server through the network.

The example embodiments described herein may be implemented using hardware components, software components, or a combination thereof. For example, the apparatus, method, and components described in the example embodiments may be implemented using a general purpose computer or special purpose computer, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may run an operating system (OS) and one or more software applications that run on the OS. The processing device also may access, store, manipulate, process, and create data in response to execution of the software. For purpose of simplicity, the description of a processing device is used as singular, however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described example embodiments, or vice versa.

While this disclosure includes example embodiments, it will be apparent to one of ordinary skill in the art that various changes in form and details may be made in these example embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or to their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of operating a counseling center server interworking with an instant messaging service, the method comprising:
receiving a message of a first user regarding a counseling request through a chat room of a channel of a second user registered in the service;
creating a first counseling ticket of the channel corresponding to the chat room based on the received message;
acquiring the number of counseling tickets in a waiting state allocated to each of accounts of a plurality of counselors linked to the channel based on a database in which information on a counseling ticket of the channel is stored;
allocating the first counseling ticket to an account of a first counselor among the accounts of the counselors based on the number of the counseling tickets in the waiting state acquired to correspond to each of the accounts of the counselors; and
updating a state of the first counseling ticket to the waiting state based on the allocation of the first counseling ticket.

2. The method of claim 1, wherein the allocating of the first counseling ticket comprises:
comparing the number of the counseling tickets in the waiting state acquired to correspond to each of the accounts of the counselors with a predetermined first threshold value; and
allocating the first counseling ticket to the account of the first counselor when the number of counseling tickets in the waiting state allocated to the account of the first counselor is less than the first threshold value, based on a result of the comparison.

3. The method of claim 1, wherein the allocating of the first counseling ticket comprises allocating the first counseling ticket to the account of the first counselor having the smallest number of allocated counseling tickets in the waiting state among the accounts of the counselors.

4. The method of claim 1, wherein the allocating of the first counseling ticket comprises:
receiving an allocation request for the first counseling ticket from a terminal of the first counselor;
comparing the number of the counseling tickets in the waiting state allocated to the account of the first counselor with a first predetermined threshold value; and
allocating the first counseling ticket to the account of the first counselor based on a result of the comparison.

5. The method of claim 1, wherein the updating of the state of the first counseling ticket to the waiting state comprises providing the chat room through a chat interface for counseling provided to a terminal of the first counselor.

6. The method of claim 5, wherein the updating of the state of the first counseling ticket to the waiting state further comprises updating the state of the first counseling ticket to a progress state in response to a connection request with the first counseling ticket received from the first counselor through the chat interface.

7. The method of claim 6, wherein the updating of the state of the first counseling ticket to the progress state comprises:
acquiring the number of counseling tickets in the progress state allocated to the account of the first counselor in response to the connection request with the first counseling ticket;
maintaining the state of the first counseling ticket when the acquired number of the counseling tickets in the progress state exceeds a predetermined second threshold value; and
updating the state of the first counseling ticket to the progress state when the acquired number of the counseling tickets in the progress state does not exceed the second threshold value.

8. The method of claim 5, wherein the connection request with the first counseling ticket comprises at least one of:
a request for access to the chat room corresponding to the first counseling ticket; and
a request for transmission of a message through the chat room corresponding to the first counseling ticket.

9. The method of claim 5, wherein the chat interface comprises:
a list of chat rooms corresponding to the counseling tickets in the waiting state allocated to the account of the first counselor; and
a list of chat rooms corresponding to progressing counseling tickets allocated to the account of the first counselor.

10. The method of claim 1, wherein the updating of the state of the first counseling ticket to the waiting state further comprises:
monitoring a state change condition of the first counseling ticket updated to the waiting state; and
updating the state of the counseling ticket to a progress state, a pending state, or an end state based on a result of the monitoring.

11. The method of claim 1, wherein the database is configured to store, to correspond to the channel, at least one of information on the account of the counselor allocated with the counseling ticket, information on the state of the counseling ticket, and information on a chat log corresponding to the counseling ticket.

12. A method of operating a counseling center server interworking with an instant messaging service, the method comprising:
receiving a message of a first user regarding a counseling request through a chat room of a channel of a second user registered in the service;
creating a first counseling ticket of the channel corresponding to the chat room based on the received message;
determining a category of the first counseling ticket based on the received message;
allocating the first counseling ticket to an account of a first counselor corresponding to the determined category among accounts of a plurality of counselors linked to the channel; and
updating a state of the first counseling ticket to a waiting state based on the allocation of the first counseling ticket.

13. The method of claim 12, wherein the allocating of the first counseling ticket comprises:
selecting accounts of second counselors corresponding to the determined category among the accounts of the counselors;
acquiring the number of counseling tickets in the waiting state allocated to each of the accounts of the second counselors based on a database in which information on a counseling ticket corresponding to counseling requested for the channel is stored; and
allocating the first counseling ticket to the account of the first counselor among the accounts of the second counselors based on the number of the counseling tickets in the waiting state acquired to correspond to each of the accounts of the second counselors.

14. A method of operating a terminal of a first counselor using a counseling service interworking with a counseling center server, the method comprising:
receiving counseling tickets allocated to an account of a first counselor and states of the allocated counseling tickets from the counseling center server;
displaying a chat interface for counseling including a list of chat rooms corresponding to the allocated counseling tickets;
receiving an input for requesting a connection to a first counseling ticket among the allocated counseling tickets from the first counselor;
receiving the state of the first counseling ticket whose update is determined based on the number of counseling tickets in a progress state among the allocated counseling tickets from the server; and
controlling the chat interface based on the received state of the first counseling ticket.

15. The method of claim 14, wherein the list of chat rooms comprises at least one list distinguished by the states of the counseling tickets.

16. The method of claim 14, wherein the controlling of the chat interface comprises:
displaying a chat room corresponding to the first counseling ticket in a first list corresponding to the progress state when the state of the first counseling ticket is updated to the progress state; and
displaying the chat room corresponding to the first counseling ticket in a second list corresponding to a waiting state when the state of the first counseling ticket is maintained in the waiting state.

17. The method of claim 14, wherein the displaying of the chat interface for counseling further comprises:
receiving a list of unallocated counseling tickets from the server;
receiving an input for requesting allocation of a second counseling ticket among the unallocated counseling tickets from the first counselor;
receiving, from the server, the state of the second counseling ticket whose update is determined based on the number of counseling tickets in a waiting state among the allocated counseling tickets; and
displaying a chat room corresponding to the second counseling ticket on the chat interface based on the received state of the second counseling ticket.

18. A computer program stored in a non-transitory computer-readable medium in combination with hardware to execute the method of claim 1.

19. A counseling center server interworking with an instant messaging service, comprising at least one processor configured to:
receive a message of a first user regarding a counseling request through a chat room of a channel of a second user registered in the service;
create a first counseling ticket of the channel corresponding to the chat room based on the received message;
acquire the number of counseling tickets in a waiting state allocated to each of accounts of a plurality of counselors linked to the channel based on a database in which information on a counseling ticket of the channel is stored;
allocate the first counseling ticket to an account of a first counselor among the accounts of the counselors based on the number of the counseling tickets in the waiting state acquired to correspond to each of the accounts of the counselors; and
update a state of the first counseling ticket to the waiting state based on the allocation of the first counseling ticket.

20. A counseling center server interworking with an instant messaging service, comprising at least one processor configured to:
receive a message of a first user regarding a counseling request through a chat room of a channel of a second user registered in the service;
create a first counseling ticket of the channel corresponding to the chat room based on the received message;
determine a category of the first counseling ticket based on the received message;
allocate the first counseling ticket to an account of a first counselor corresponding to the determined category among accounts of a plurality of counselors linked to the channel; and
update a state of the first counseling ticket to a waiting state based on the allocation of the first counseling ticket.

21. A terminal of a first counselor using a counseling service interworking with a counseling center server, the terminal comprising at least one processor configured to:
receive counseling tickets allocated to a logged-in account and states of the allocated counseling tickets from the counseling center server;
display a chat interface for counseling including a list of chat rooms corresponding to the allocated counseling tickets;
receive an input for requesting a connection to a first counseling ticket among the allocated counseling tickets;
receive the state of the first counseling ticket whose update is determined based on the number of counseling tickets in a progress state among the allocated counseling tickets from the server; and
control the chat interface based on the received state of the first counseling ticket.
